(19) United States
(12) Patent Application Publication
(10) Pub. No.: US 2009/0313429 A1
(43) Pub. Date: Dec. 17, 2009

(54) Disk-based operating environment management system and method thereof

(76) Inventor: Ching-Feng Lee, Fongyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,886

(22) Filed: Mar. 4, 2009

(30) Foreign Application Priority Data
Jun. 11, 2008 (TW) 97121696

(51) Int. Cl. G06F 12/08

(52) U.S. Cl. 711/114; 711/E12.019

(57) ABSTRACT

A method for managing disk-based operating environment for one or more host computers is provided. The environment management method includes the following steps: first, providing a plurality of operating systems together with specific application environments; then, selecting at least one operating system with specific application environment based on the user's preference and according to the authority of the host; finally, the host loading and executing the operating system to boot up specific operating environment.

### BACKGROUND OF THE INVENTION

1. Field of the Invention

The present invention generally relates to a disk management system and the method thereof; in particular, to a disk-based operating environment management system suitable for boot process and method thereof.

2. Description of Related Art

The boot process for current computer systems essentially starts with the Basic Input/Output System (BIOS) codes executing the Power On Self Test (POST) process during startup, initializing software and hardware, then seeking auxiliary boot devices configured for guiding operation system loading, further executing the relevant boot procedures obtained from the auxiliary boot devices to successfully load the operating system. Herein said auxiliary boot devices are generally a hard disk drive, soft disk drive, CD/DVD drive or another portable storage device (such as USB thumb drive or USB hard disk) supported by the BIOS as boot devices. In particular, in the auxiliary boot devices, a boot loader is provided, which defines all configuration files and information on the relevant environment parameters, as well as providing functions for loading operating system kernel.

Refer now to FIG. 1, wherein a diagram of system architecture for an embodiment of a prior art host is shown. As illustrated in FIG. 1, the host 1 comprises a memory module 11, a processing unit 17, a system chip module 19 and a data transfer control chip 13. The memory module 11 stores system programs including the boot loader and operating systems. The boot loader contains configured environment parameters and program codes to facilitate successful loading of the operating system kernel.

During the startup process, the processing unit 17, which is coupled between the system chip module 19 and the memory module 11, first issues control instructions to the memory module 11 requesting a small piece of system program called the boot loader strap, and transfers such system program code acquired from the memory module 11 to the system chip module 19. The system chip module 19 consists of a system storage unit 191 for storing the above-said system program. After the system program has been stored in the system storage unit, the processing unit 17 executes the system program which will then proceed to load and hand control to the operation system codes and complete the startup action.

The data transfer control chip 13 is coupled between the memory module 11 and processing unit 17, and is used to transfer the system program according to the control instructions issued by the processing unit 17. In practice, said system program consists of the code segments of the boot loader strap and the operating system.

In a general computer system, due to various user requirements, the operating environment can vary. For example, the operating system configurations and applications programs required for executing accounting procedures are different from those required for text processing. Currently, most enterprises and companies provide all users with one or limited number of common operating environment comprising a combination of the most general operating system configurations and application programs. Although this seemingly universal strategy is from the installation perspective, it suffers disadvantages of low operational performance and significant waste of computing resources. Prior art disk boot management programs allow users to select from among multiple combinations of operating system configurations and application programs. When a user starts up a computer system installed with such “boot manager”, he is first prompted for selection from among the operating systems environment available on the disk to perform his desired boot actions. However, as the disk space required for storing the combinations of operating systems and application programs will keep growing as more varieties of operating systems and application programs are added on the user's demand, it is inevitable to encounter the problem of storage space exhaustion, thus restricting the flexibility for adding combinations of operating systems and applications.

Furthermore, in the case where multiple users share the same computer system at different period of time, each user may be authorized to access certain combinations of operating systems and applications programs that are different from others, and thus, in an environment where multiple combinations of operating systems and application programs have to be supported on a computer, a new system architecture with improved management mechanism is required to perform suitable dispatching and management functions on the all combinations of operating environment that includes systems and application programs.

### SUMMARY OF THE INVENTION

In view of the aforementioned issues, the present invention is proposed to provide a disk-based operating environment management system and method thereof, which offers an independent disk management unit between the processing unit and the memory module for dispatching and managing, according to authorization granted upon the user, system programs stored in the memory module such that it is possible to dynamically perform processes like adding, removing and searching the system programs, in order to improve the mechanism for expanding available system program combinations, and to achieve more flexibility in user's selection of bootable operating environments which are centrally managed.

Therefore, one objective of the present invention is to provide a disk-based operating environment management system and method thereof in order to defeat the limitation on the number of combinations of system programs available on a computer.

Another objective of the present invention is to provide a disk-based operating environment management system and method thereof so as for the computer to gain operating performance, to achieve resource saving, and to indirectly improve on system boot performance, by providing more combinations of operating systems and application programs for user to select from, with each environment combination being significantly more economic on computing resources.

The present invention also discloses a disk management system which is applicable to a host. Said disk management system comprises a memory module, a disc management unit, a system chip module, a processing unit and a data transfer control chip. Said memory module consists of a plurality of memory units, each memory unit storing a set of system programs, in which the system programs including an operating system; the disk management unit is coupled to the memory module for managing said memory units, and selects a set of system programs stored in one of said memory units to act as the boot programs of the host; the data transfer control chip is coupled between the memory module and the disk management unit for transferring the system programs based on the control instructions issued by the disk management unit; the system chip module comprises a system storage unit for storing the system programs selected by the disk management unit; the processing unit is coupled between the disk management unit and the system chip module for executing the operating system stored in the system chip module, so as to further complete the boot actions.

The present invention also discloses a disk management system which is applicable to a host. Said disk management system comprises a server, a system chip module and a processing unit. Herein the system chip module and the processing unit are installed within the host. The server is coupled to the host through a network, and said server consists of a memory module, a disk management unit and a data transfer control chip.

The memory module comprises a plurality of memory units, each memory unit storing a set of system programs, which includes an operating system; the disk management unit is coupled to the memory module for managing said memory units, and selects a set of system programs stored in one memory unit to boot the host; the data transfer control chip is coupled between the memory module and the disk management unit for transferring the selected set of system programs to the host through network based on the control instructions issued by the disk management unit. The system chip module located at the host comprises a system storage unit for storing the system programs selected by the disk management unit; the processing unit is coupled to the system chip module and also coupled to the disk management unit via network for executing the system programs stored in the system chip module, so as to further complete the boot actions.

In an embodiment according to the present invention, said disk management unit has a data operation instruction set which consists of a plurality of data operation instructions for defining the transfer, access and management on the memory units. The disk management unit issues data operation instructions to the data transfer control chip to perform corresponding processes on the system programs contained in each memory unit.

The present invention also discloses a management method for the disk-based operating environment which is applicable to a host. The steps of said management method for the disk-based operating environment consist of, first, providing a plurality of systems programs, wherein the system programs include at least an operation system; next, selecting one of the system programs based on the authorization granted on the host and the demand of the user; finally, loading and executing, by the host, the selected system programs including the operating system to perform boot actions.

In an embodiment according to the present invention, the host has a plurality of memory units, each memory unit storing one of the combinations of operating systems and application systems. In the step of executing the system programs it further comprises the following steps: executing a snapshot procedure to generate a snapshot for recording the state of the operating system executed by the host; or executing a rollback procedure to restore the operating system executed by the host to the one recorded in the snapshot.

In an embodiment according to the present invention, the host is connected to a server through a network, which server has a plurality of memory units, each of the memory units storing one of the combinations of operating systems and application systems. In the step of the host selecting and booting the operating system it further comprises a step of executing a disk management procedure, and the disk management procedure consists of the following steps: executing a snapshot procedure to generate at least one snapshot on each host for recording the state of the operating system executed by the host; or executing a rollback procedure to restore the operating system to be executed by the host to the one recorded in the snapshot.

By means of the aforementioned technical solutions, the present invention employs centralized management to handle multiple system programs, and dispatches system programs to the computer system based on the authorization granted on the computer and user's demand for executing the boot process, so as to further achieve the objectives of diskless boot with enhanced performance.

The above-illustrated Summary as well as the subsequent Detailed Descriptions and appended Drawings are all for further setting out the approaches, means and effects taken by the present invention to reach the prescribed objectives. Other purposes and advantages related to the present invention will be thoroughly construed in the subsequent Detailed Descriptions and appended Drawings.

### BRIEF DESCRIPTION OF THE DRAWINGS

FIG. 1 is a diagram of system architecture for an embodiment of a prior art host;

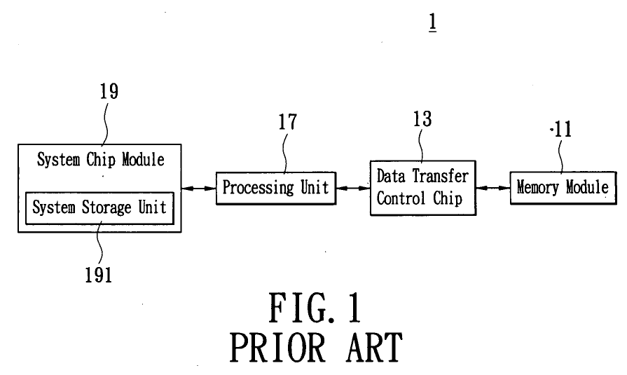

FIG. 2 is a diagram of system architecture for an embodiment of the disk management system according to the present invention;

FIG. 3 is a diagram of system architecture for another embodiment of the disk management system according to the present invention; and

FIG. 4 is a flowchart of an embodiment of the disk management method according to the present invention.

### DETAILED DESCRIPTION OF PREFERRED EMBODIMENTS

The disk-based operating environment management system and method thereof proposed by the present invention provides an independent disk management unit for all system programs, the management functions include dispatching the system programs based on the host's authority and user's demand, and dynamically performing such operations as adding, removing, search etc. on the system program, in order to increase the number of system programs accommodated and, by using centralized boot management, to achieve the objective of diskless boot of the host with enhanced performance.

The essential technical characteristics of the present invention lie in an independent disk management unit which operates based on a set of data operation instructions to transfer, access, manage (including add, remove, search, rename, copy) the plurality of memory units. Said data operation instructions allow centralized handling of the system programs to provide the on-demand boot system and method thereof, and hereunder only the required internal system architecture and action flows thereof are discussed; however, those skilled in the art can appreciate that, in addition to the elements described as below, the host and its boot process certainly include other necessary components and steps, and as a result are by no means limited to these disclosed in the present embodiment.

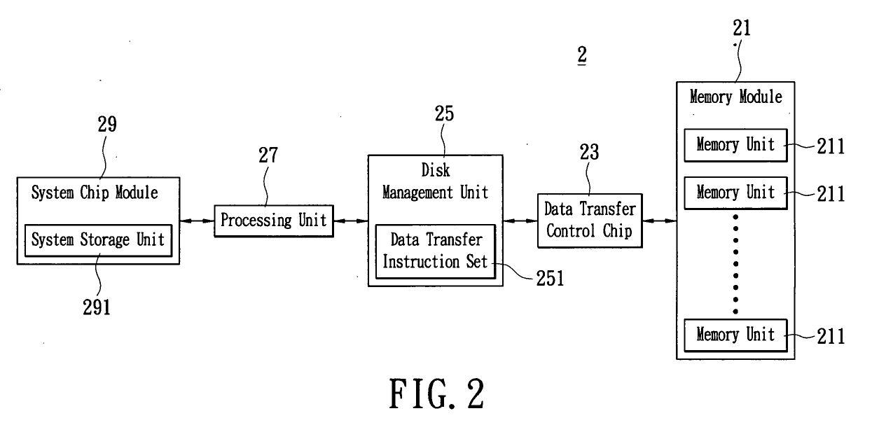

Initially, refer to FIG. 2, wherein a diagram of system architecture for an embodiment of the disk management system according to the present invention is shown. As illustrated in Figure, 2, the disk management system 2 is applied in a host (not shown), comprising a memory module 21, a disk management unit 25, a system chip module 29, a processing unit 27 and a data transfer control chip 23. The memory module 21 consists of a plurality of memory units 211, each memory unit 211 stores an operating system. In practice, these operating systems may include groups of such disk operating systems as UNIX, LINUX, BSD, MAC, IBM operating system, Windows operating system, or others.

The system chip module 29 includes a system storage unit 291 used to store the operating systems for host boot. In practice, the system chip module 29 is installed in the ROM BIOS on the motherboard. The processing unit 27 is coupled between the memory module 21 and the system chip module 29, and is used to issue control instructions to the memory module 21 to acquire the required operating system during boot process.

The disk management unit 25 is coupled between the processing unit 27 and the memory module 21 for managing said plurality of memory units 211. The disk management unit 25 has a data operation instruction set which consists of a plurality of data operation instructions for defining the transfer, access, management on said plurality of memory units storing therein the system programs. In practice, said data operation instruction set may be an expansion of one of the SATA control instruction set, ATA control instruction set, IDE control instruction set or PCI control instruction set. The additional instructions issued by the processing unit 27 to the memory module 21 when executing the boot code segments is provided to manage the systems programs stored in the memory units 211 through the disk management unit 25, until the user or the host has selected to use a specific combination of system programs from memory units 211 for normal boot execution, in which the base data operation instructions are passed on by the disk management unit 25 to the memory module 21 for further transferring the selected system programs to the system storage unit 291 to be stored therein, thus allowing the processing unit 27 to perform and complete the boot actions.

The data transfer control chip 23 is coupled between the memory module 21 and the disk management unit 25 for transferring system programs including the operating system based on the data operation instructions issued by the disk management unit 25. In an embodiment, the data transfer control chip 23 uses one of the SATA interface, ATA interface, IDE interface or PCI interface to perform data transfer.

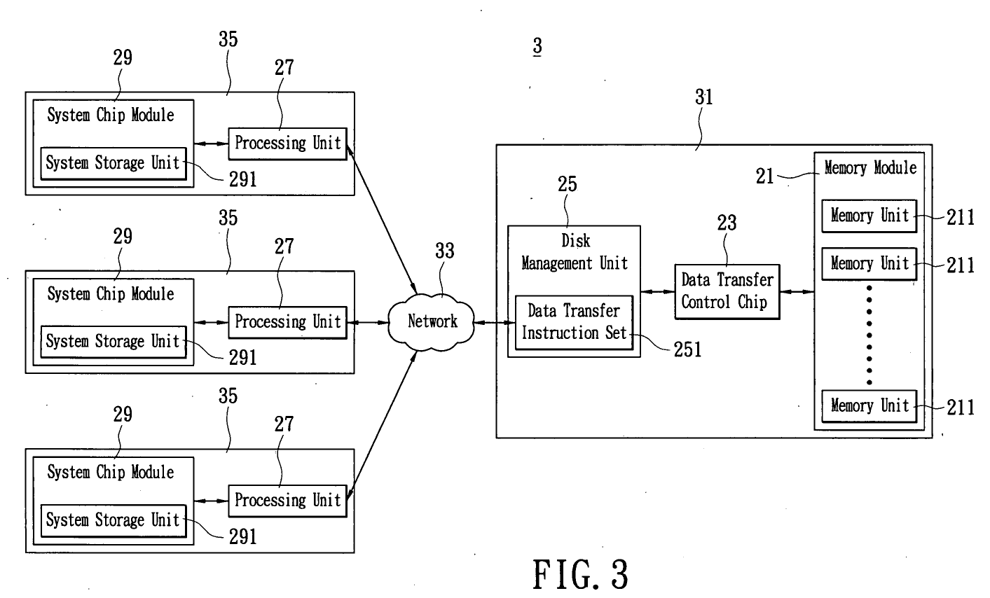

Subsequently, please refer to FIG. 3, wherein a diagram of system architecture for another embodiment of the disk management system according to the present invention is shown. When compared with the system architecture shown in FIG. 2, the disk management system in FIG. 3 further comprises a server 31 consisting of the memory module 21, the disk management unit 25 and the data transfer control chip 23. The server 31 is connected to multiple hosts 35 via a network 33 for further providing and managing the required operating systems during the boot of each host 35. Herein the host 35 comprises the processing unit 27 and the system chip module 29, and the network 33 can also be replaced by any type of transmission media.

In the process of booting, the host, it first downloads, from the remote server 31 through the network 33, the system programs containing expanded data operation instructions which the host issues to instruct the disk management unit 25 for management of the memory module 21 in the remote server 31. Afterward, the host 35 requires the operating system from the disk management unit 25 by way of the network 33, and the disk management unit 25 selects at least one operating system to allow the host 35 to download; and then the selected operating system will be stored in the system storage unit 291 to be later executed by the processing unit 27 for completion of boot process.

Said disk management unit 25 can handle the configurations of the memory units 211, also including procedures such as adding, removal, searching, renaming and copying of operating system, and consisting of snapshot and rollback procedures to be performed on specific operating system as well, which should not be considered as being limited to those disclosed by the present embodiment.

In an embodiment according to the present invention, said host can allow at least one user to log in for use, as a result the disk management unit 25 may select to provide which operating systems based on the authorization granted on the host and the demand of the user logging into the host, allowing the user to download for booting on the host.

In an embodiment according to the present invention, said memory module 21 can be selected from a group containing any one of a hard disk drive, a CD drive, a USB thumb drive, or a floppy disk drive.

In an embodiment according to the present invention, said memory unit 211 and the system storage unit 291 can be selected from a group containing any one of Flash Memory, Read Only Memory (ROM), Erasable Read Only Memory (EROM), Electrically Erasable Read Only Memory (EEROM), Erasable Programmable Read Only Memory (EPROM) or Electrically Erasable Programmable Read Only Memory (EEPROM).

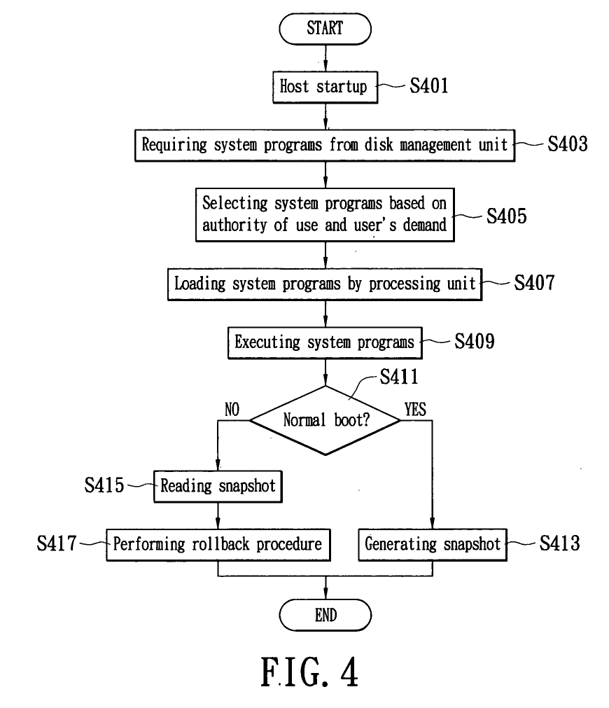

To further understand the operations of the present invention in details, refer now to FIG. 4 in conjunction with FIGS. 2 and 3, wherein FIG. 4 shows a flowchart of an embodiment of the management method for the disk-based operating environment according to the present invention. As illustrated in FIG. 4, said management method for the disk-based operating environment comprises the following steps:

initially, a user powers on a host (step S401). In an embodiment, the host may allow to be shared by multiple users, and each user has respective attributes and authority; subsequently, the processing unit 27 issues a requisition instruction for authorized list of operating systems to the disk management unit 25 (step S403); upon the reception of the issued instruction, it selects the appropriate memory units 211 from the memory module 21 and the operating system stored therein based on the authorization granted on the host and the demand of the user logging into the host to facilitate boot process (step S405);

next, the processing unit 27 loads the operating system selected by the user and dispatched by the disk management unit 25 and stores it to the system storage unit 291 (step S407). In an embodiment, in case the disk management system depicted in FIG. 3 is employed, the processing unit 27 then downloads the selected operating system from the disk management unit 25 to the host 35 through the network 33 and stores it to the system storage unit 291; then, the processing unit 27 executes the downloaded operating system for performing the boot process (step S209);

finally, the method determines whether the operating system can be correctly executed for normal boot up (step S411); if yes, then a snapshot procedure is performed (step S413) for generating a snapshot of the normal state of the operating system executed by the host to enable rollback upon the occurrence of possible future boot failure or system crash; in an embodiment, it may be set to generate a fixed amount of snapshots to retain robust system states at multiple points of time to allow users to flexibly select the point of time to which the system is to be rolled back; if the determination at step S4 11 is no, indicating a boot failure, then it reads a previously saved snapshot (step S415) and performs a rollback procedure based on the snapshot (step S417), so as to restore the state of the host back to robust operating system operation.

In an embodiment according to the present invention, such as the configuration of the disk management system shown in FIG. 3, after step S411, the disk management unit 25 further allows execution of a series of step of disk management procedures which comprise the following steps: generating at least one snapshot at each connection of the host to the server 31 for recording a robust state of the operating system executed by the host; and, upon the occurrence of boot failure on any host, restoring the host to the robust state of the operating system which is the previously generated snapshot when the operation system is operating normally.

As discussed above, the server 31 may suitably allocate the system programs to the hosts 31 on the network in accordance with the authorization granted on the hosts so as to centrally manage multiple hosts 35, such that each host 35 need not to have a disk for storing system programs, thus further achieving the architecture of diskless boot process.

By means of the aforementioned embodiments, it can be appreciated that the disk-based operating environment management system and method thereof according to the present invention uses the disk management unit to centralize the management of dispatching of all available system programs, in this way it is possible not only to massively expand the number of supported system programs, but efficiently handle the system programs to enhance system performance, and also reduce the hardware equipment requirements on the hosts, thus further facilitating cost saving as well as less required storage space on each host.

The texts illustrated as above discuss merely the detailed descriptions and appended drawings of the embodiments according to the present invention, and are not meant to limit the present invention at all. All scope of the present invention should be based on the subsequent claims, and any changes or modifications that skilled one in the arts can conveniently consider in the field of the present invention are all deemed to be embraced by the scope of the present invention delineated in the following claims.

What is claimed is:

1. A disk management system which is applicable to a host, said disk management system comprising:
a memory module, which consists of a plurality of memory units, each memory unit storing a set of system programs, whereby the set of system programs include at least an operating system;
a disc management unit, which is coupled to the memory module for managing said memory units;
a system chip module, which comprises a system storage unit for storing the system programs selected by the disk management unit; and
a processing unit, which is coupled between the disk management unit and the system chip module for accessing or executing the system programs stored in the system chip module;
wherein the disk management unit selects a set of system programs stored in at least one memory unit to transfer the system programs to the system storage unit for storage, allowing the processing unit to execute and complete the boot process.

2. The disk management system according to claim 1, wherein the disk management unit has a data transfer instruction set which consists of a plurality of data operation instructions for defining the methods of transferring, accessing and managing said plurality of memory units.

3. The disk management system according to claim 2, further comprising:
a data transfer control chip, which is coupled between the memory module and the disk management unit for transferring the system programs based on the control instructions issued by the disk management unit.

4. The disk management system according to claim 3, wherein the host comprises the processing unit and the system chip module.

5. The disk management system according to claim 4, further comprising:
a server, which consists of the memory module, the disk management unit and the data transfer control chip;
wherein the disk management system is coupled between the host and the server through a network so as to transfer the system programs stored in the memory units.

6. The disk management system according to claim 3, wherein the system programs include groups of disk operating systems such as UNIX, LINUX, BSD, MAC operating systems, IBM operating system or Microsoft Windows operating system.

7. The disk, management system according to claim 5, wherein the system programs include groups of disk operating systems such as UNIX, LINUX, BSD, MAC operating systems, IBM operating system or Windows operating system.

8. The disk management system according to claim 3, wherein the memory module is selected from a group containing any one of hard disk drive, CD drive, USB thumb drive, or floppy disk drive.

9. The disk management system according to claim 5, wherein the memory module is selected from a group containing any one of hard disk drive, CD drive, USB thumb drive, floppy disk drive.

10. The disk management system according to claim 3, wherein the data transfer control chip uses one of the SATA interface, ATA interface, IDE interface or PCI interface.

11. The disk management system according to claim 5, wherein the data transfer control chip uses one of the SATA interface, ATA interface, IDE interface or PCI interface.

12. The disk management system according to claim 2, wherein the data operation instruction set is an expansion of the data transfer instruction set as used by one of the following data transferring protocols: SATA, ATA, IDE, or PCI.

13. A management method for the disk-based operating environment which is applicable to a host, wherein the steps of said management method for the disk-based operating environment consist of:
providing a plurality of sets of system programs, wherein a set of system programs includes at least an operating system;
selecting one of the plurality of sets of system programs based on authorization granted on the host and user's demand; and
loading and executing by the host, the selected set of system programs to perform boot actions.

14. The management method for the disk-based operating environment according to claim 13, wherein the host has a plurality of memory units and each memory unit stores one of the set of system programs which includes an operating system.

15. The management method for the disk-based operating environment according to claim 13, wherein the host is connected to a server through a network, the server consists of a plurality of memory units and each memory unit stores one of the set of system programs.

16. The management method for the disk-based operating environment according to claim 14, wherein the host loads the corresponding set of system programs from the plurality of memory units.

17. The management method for the disk-based operating environment according to claim 15, wherein the host loads the corresponding set of system programs from the plurality of memory units.

18. The management method for the disk-based operating environment according to claim 13, wherein in the steps of executing the set of system programs, further comprise the following steps:
executing a snapshot procedure for generating at least one snapshot in order to record the state of the operating system executed by the host; and
executing a rollback procedure to restore the operating system executed by the host back to the operating system recorded in the snapshot.

19. The management method for the disk-based operating environment according to claim 13, wherein the host allows at least one user to log in, and the step of selecting at least one operating system based on the authority of the host further comprises selecting the operating system based on the authority and demand of the user logging into the host.

20. The management method for the disk-based operating environment according to claim 15, wherein in the step of executing the operating system further comprises a step of executing a disk management procedure, the disk management procedure consisting of the following steps:
executing a snapshot procedure at each host for generating at least one snapshot in order to record the status of the operating system executed by the host; and
executing a rollback procedure to restore the status of the operating system executed by the host to the operating system status recorded in the snapshot.

21. The management method for the disk-based operating environment according to claim 18, wherein, before the step of executing the rollback procedure further comprising a step of determining whether the host performs robust boot procedure, and in the case that robust boot has failed, starting the rollback procedure.

22. The management method for the disk-based operating environment according to claim 20, wherein, before the step of executing the rollback procedure further comprising a step of determining whether the host performs a robust boot procedure, and in case that robust boot has failed, starting the rollback procedure.
